(19) United States
(12) Patent Application Publication
(10) Pub. No.: US 2011/0296675 A1
(43) Pub. Date: Dec. 8, 2011

(54) MEANS FOR RAPIDLY ASSEMBLING A SPACECRAFT

(76) Inventors: Roopnarine, New York, NY (US); Shazad Sadick, Queens Village, NY (US)

(21) Appl. No.: 12/859,667

(22) Filed: Aug. 19, 2010

Related U.S. Application Data
(60) Provisional application No. 61/272,175, filed on Aug. 26, 2009.

(51) Int. Cl. B23P 19/00

(52) U.S. Cl. 29/700

(57) ABSTRACT

A structure for rapid assembly of a self-contained apparatus, such as a spacecraft or satellite, has horizontal and vertical manifolds joined at corners to form a rigid self-contained frame, side panels attached by fasteners inserted into the vertical and horizontal manifolds, and top and bottom panels attached by fasteners inserted into the horizontal manifolds. Cutout sections are provided on opposite ends of each manifold to enable electrical and/or fluid lines to extend across the corners formed by the manifolds. The vertical manifolds can have a 90-degree angle for a square or rectangular shaped spacecraft, while a 120-degree angle creates a hexagonal shaped spacecraft. A hinged vertical manifold may be used for two different angular configurations. An alternate embodiment employs quick-insertion-nut (QIN) assemblies embedded into the edges of the side panels to which the top and bottom panels are directly fastened to eliminate the use of manifolds.

This U.S. Patent Application claims the priority of U.S. Provisional Application 61/272,175 filed on Aug. 26, 2009.

This invention was made with Government support under Contract No. FA9453-07-M-0113 awarded by the U.S. Air Force. The Government has certain rights in the invention.

### TECHNICAL FIELD

The described invention relates to a means for rapid assembly of a self enclosed apparatus, such as a spacecraft or satellite, using uniform structural parts designed to allow a wide range of assembly designs and incorporated apparatus functions.

### BACKGROUND OF INVENTION

It has been a goal in national space programs to enable turn-around of a tactical satellite within a short time, such as a few days, from mission call-up to on-orbit operation. The ability to produce a spacecraft quickly to order would be a vast improvement from the current norm of large, complex, and costly custom spacecraft that require a period of years to design and deploy. More recently, producing custom spacecraft to order have improved in deployment timescales of approximately several months to two years with developments in more modular small satellites produced on a shorter timescale. Such an operationally responsive spacecraft production capability will also prove useful to other members of the space community interested in low-cost rapid access to space including NASA, university research groups, other members of the science community, and the commercial space industry.

Considerable attention has been paid to modular architectures for standardizing spacecraft. This includes the use of standardized bus structures and electrical connections and plug and play avionics. Some modular spacecraft bus architectures may require a number of modules to be pieced together, which could result in additional mass, or require atypical geometries. In addition, while they enable integration of independent spacecraft components, these and more typical rectangular panel-based spacecraft bus structures still suffer from long assembly times.

Assembly, integration and test typically account for 6 months to 2 years of the spacecraft production cycle. This process could be drastically reduced by stocking component-ready modular panels for assembly. Even with the pieces of a spacecraft bus and payload prepared for integration, the assembly of the structure itself needs to be sped from the typical process of securing panels with dozens of mixed-size fasteners and the associated verification, tooling, and documentation. Likewise, assembly of the structure also must take into consideration the need to pass electrical and thermal connections across the panels of the bus. It will also be crucial to demonstrate quick disassembly of bus panels in order to swap out faulty components or support last-minute component changes to satisfy changing mission needs.

However, the current state-of-the-art has not attained an optimum means for rapidly assembling a spacecraft. Current state-of-the-art still involves using numerous standard fasteners to hold many structural panels in place by conventional fastener or mounting structures that must be added piece-meal to a conglomeration. The use of conventional fasteners for assembling panels is a time-consuming process and is not conducive to rapid assembly of a spacecraft.

### SUMMARY OF INVENTION

In accordance with the present invention, a means for rapid assembly of a self-contained apparatus, such as a spacecraft or satellite, employs horizontal and vertical structural manifolds which are joined at corners with one another to form a rigid self-contained frame, and a plurality of side panels are attached on external sides to the vertical and horizontal manifolds, and top and bottom panels are attached on respective top and bottom sides to the horizontal manifolds. The vertical and horizontal manifolds enable side panel-to-panel attachment at vertical and horizontal corners, and horizontal manifolds enable top and bottom panel attachment at horizontal corners with the side panels. The combination of vertical and horizontal manifolds creates a skeletal frame for the self-contained apparatus to which the top, bottom and side panels are attached to the manifolds using integrated or embedded fasteners which are readily aligned and fastened.

In preferred embodiments, cutout sections are provided proximate opposite ends of each manifold to enable electrical and/or fluid lines to be emplaced on internal sides of the panels with recessed seating and continuity across the vertical and horizontal corners formed by the manifolds.

The angled shape of the vertical manifold determines the shape of the self-contained apparatus, i.e., spacecraft. A 90-degree angled vertical manifold creates a square or rectangular shaped spacecraft, while a 120-degree angled vertical manifold creates a frame for a hexagonal shaped spacecraft.

A variation to the fixed-angle vertical manifold is a hinged vertical manifold capable of at least two different angular configurations for the rapid assembly of differently shaped structures (square, rectangular or hexagonal).

An alternate embodiment of the invention employs quick-insertion-nut (QIN) assemblies that are embedded into the edges of the side panels to eliminate the use of manifolds. The embedded quick-insertion-nut (QIN) assemblies enable the top and bottom panels to be directly fastened to the edges of side panels.

Other objects, features, and advantages of the present invention will be explained in the following detailed description of the invention having reference to the appended drawings.

### BRIEF DESCRIPTION OF DRAWINGS

FIG. 1 illustrates a self-contained apparatus, such as a spacecraft or satellite, formed in accordance with the present invention.

FIG. 2 illustrates an internal frame of the self-contained apparatus formed by vertical manifolds and horizontal manifolds.

FIG. 2A shows the external (panel mounting) surfaces of the horizontal manifold in greater detail.

FIG. 2B shows the internal (fastener-nut holding) surfaces of the horizontal manifold in greater detail.

FIG. 2C shows the external sides and FIG. 2D shows the internal sides of an end of the horizontal manifold in greater detail.

FIGS. 3A and 3B show the use of 120-degree angled vertical manifolds to form a frame for a hexagonal shaped apparatus.

FIGS. 4A and 4B show a hinged-type vertical manifold with pins inserted through the hinge joints forming the vertical corner.

FIGS. 5A and 5B illustrate a partial assembly view and an exploded assembly view, respectively, for a square-shaped spacecraft with manifolds.

FIGS. 6A-6E illustrate the assembly sequence in steps for the square-shaped spacecraft with manifolds.

FIGS. 7A-7C show an example of wire routes and connector mounting on the panels.

FIGS. 8A and 8B show an example of electrical loop connection on the panels.

FIGS. 9A-9C illustrate the alignment of connectors on the panels and the horizontal manifolds during assembly.

FIGS. 10A and 10B illustrate an alternate embodiment of the invention in which quick-insertion-nut (QIN) assemblies are embedded into the edges of the side panels to eliminate the use of manifolds.

FIGS. 11A and 11B show an assembled view and an exploded view, respectively, of the alternate embodiment using the embedded quick-insertion-nut (QIN) assemblies.

### DESCRIPTION OF EMBODIMENTS

In the following detailed description of the invention, certain preferred embodiments are illustrated providing certain specific details of their implementation. However, it will be recognized by one skilled in the art that many other variations and modifications may be made given the disclosed principles of the invention.

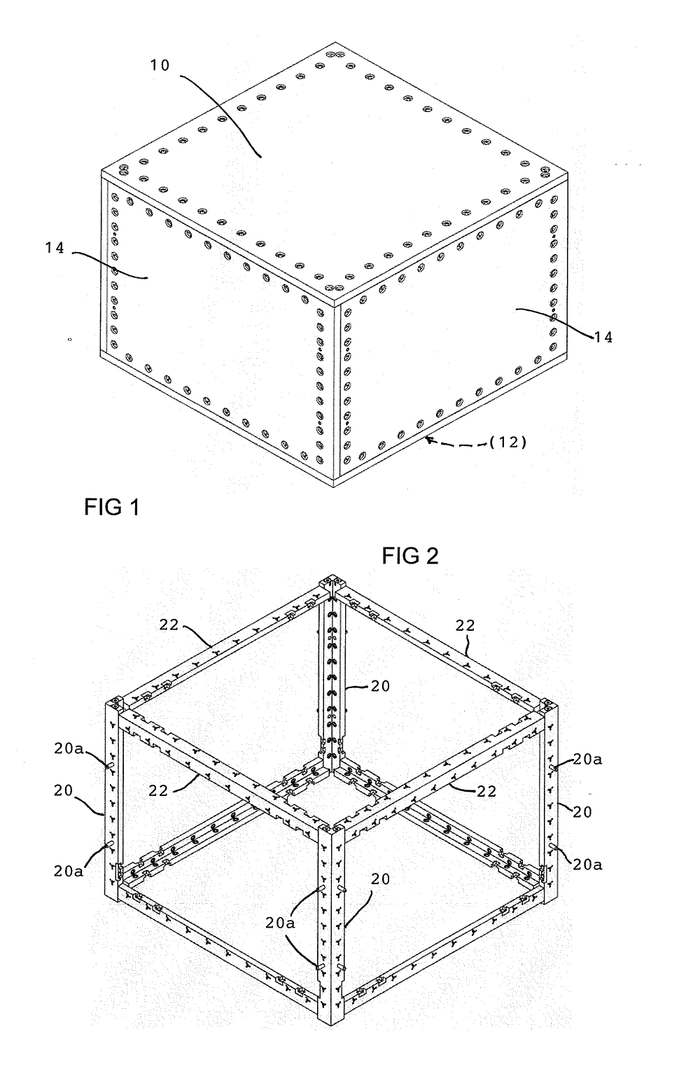

FIG. 1 illustrates a self-contained apparatus, such as a spacecraft or satellite, formed with top panel 10, bottom panel 12 (on the underside of apparatus), and a plurality of side panels 14. Each panel is fastened by a row of fasteners along each side adjacent a corresponding side of another panel. The side panels 14 have adjacent sides along the vertical corners, and the side panels 14 also have adjacent sides with the top and bottom panels 10, 12 along the horizontal corners of the external panel surface structure of the apparatus.

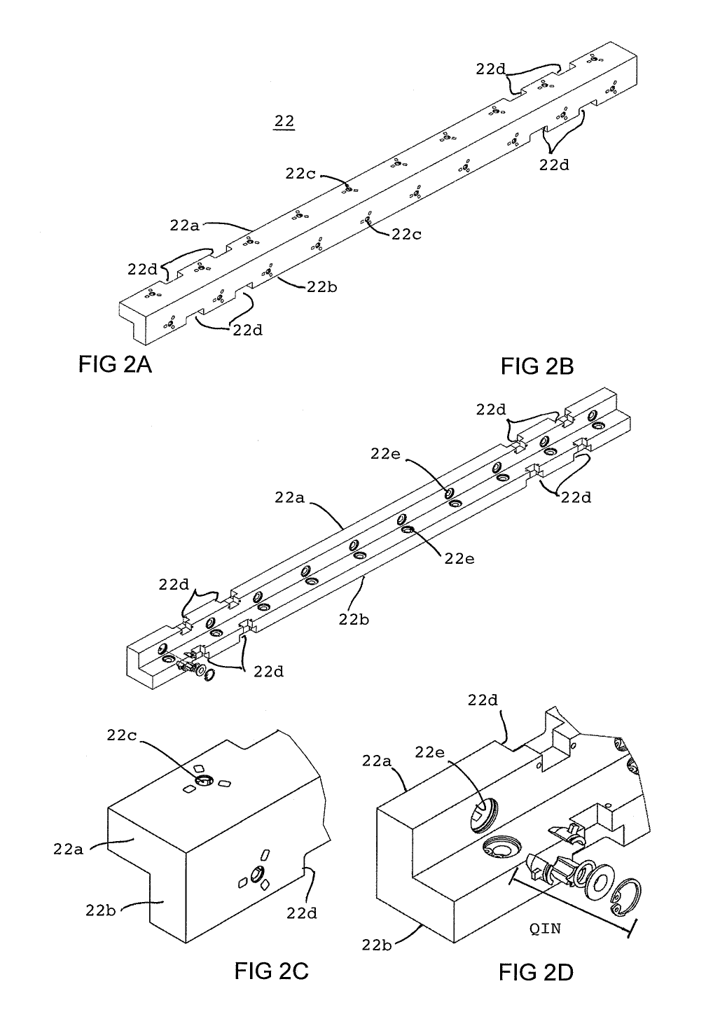

FIG. 2 illustrates the internal frame of the self-contained apparatus formed by vertical manifolds 20 and horizontal manifolds 22. Each manifold is formed by a pair of manifold halves arranged perpendicular to the other (for rectangular shape) or angled to each other (for other polygon shapes). Each manifold half has alignment holes along its length for receiving fastener bolts inserted from the external sides of a panel to pass through the external sides of the manifold halves and fasten respective nuts held on the internal sides of the manifold halves. Alignment studs 20a are provided to project from the external sides of the vertical manifold halves for aligning the side panels thereon.

FIG. 2A shows the external (panel mounting) surfaces of the manifold halves 22a, 22b of a horizontal manifold 22 in greater detail. Each manifold half has a row of alignment holes 22c along its length for receiving fastener bolts inserted from an external side of an attached panel. A pair of cutout sections 22d is provided proximate opposite ends of each horizontal manifold to enable electrical and/or fluid lines to be emplaced on internal sides of a panels. The cutout sections allow the lines to be recessed in their seating for continuity across the horizontal corners formed by the horizontal manifolds.

FIG. 2B shows the internal (fastener-nut holding) surfaces of the manifold halves 22a, 22b of a horizontal manifold 22 in greater detail. Each manifold half has a row of integrated nut holding receptacles 22e along its length for receiving and tightening the ends of fastener bolts inserted from an external side of an attached panel. The cutout sections 22d are shown.

FIG. 2C shows the external sides of an end of the horizontal manifold 22 in greater detail. FIG. 2D shows the internal sides of the end of the horizontal manifold 22 in greater detail. QIN denotes a preferred type of quick-insertion-nut which is retained in the integrated nut holding receptacles 22e.

For preferred use, a quick insertion nut (QIN bracketed in FIG. 2D) of the type described in U.S. Pat. No. 6,712,574 to Roopnarine, issued Mar. 30, 2004, has an internally threaded nut adapted to be quickly attached and tightened on an externally threaded bolt end inserted therein. The quick insertion nut is formed with a casing having an internal surface at a front part thereof in a frusto-conical shape with a taper angle, the front part of the casing being oriented toward the bolt end for insertion. A plurality of shell segments are radially arranged on a fastener axis to form a displaceable shell assembly contained in the casing, each of the shell segments having a similar shape with an external surface at a front end thereof tapered in a frusto-conical shape with a taper angle corresponding to the taper of the internal front surface of the casing. A spring is positioned at a rear part of the casing to provide an elastic force to elastically hold rear ends of the shell segments together in the shell assembly. An retainer ring is provided at the rear part of the casing having a taper for engaging the rear ends of the shell segments and displacing them radially as they are moved axially toward the end retainer such that the shell segments are spread apart radially to allow insertion of the bolt end past the internal threads of the shell segments when the shell segments are pushed axially by the bolt end into the front part of the casing and toward the ring retainer at the rear part of the casing. A more detailed explanation is provided in U.S. Pat. No. 6,712,574 which is incorporated by reference herein.

The vertical manifolds enable side panel-to-panel attachment at vertical corners, while the horizontal manifolds enable top and bottom panel attachment at horizontal corners with the side panels. The combination of vertical and horizontal manifolds creates a skeletal frame for the self-contained apparatus to which the top, bottom and side panels are attached to the manifolds using integrated or embedded fasteners which are readily aligned and fastened. The skeletal frame increases rigidity of the apparatus and thereby increases its overall fundamental frequency. For use to form a satellite, the manifolds serve as structural beams and provide good contact at the interfaces between panels to enable thermal transfer by conduction and thereby enhance heat dissipation and distribution and reduce thermal gradients across the satellite. Integrated within the manifolds are the quick insertion nuts for mounting the panels as shown in FIG. 2. This attachment strategy provides structural integrity in tension, compression, shear and torsion.

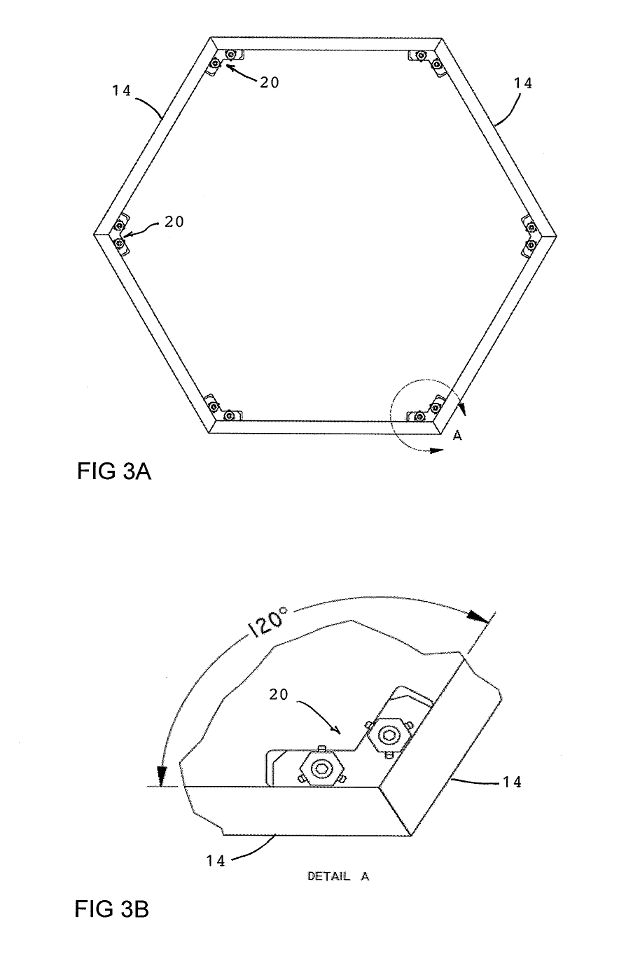

The angled shape of the vertical manifold determines the shape of the self-contained apparatus, i.e., spacecraft. A 90-degree angled vertical manifold creates a square or rectangular shaped spacecraft, while a 120-degree angled vertical manifold creates a frame for a hexagonal shaped spacecraft, as shown in FIGS. 3A and 3B.

For stacking architectures, the skeletal manifolds attachment strategy also lends itself to assembly of multiple component decks within the bus. The attachment strategy may also be used for assembling components to the panels as well, although this may be done with direct component-to-panel connections with the QINs rather than with a manifold in between.

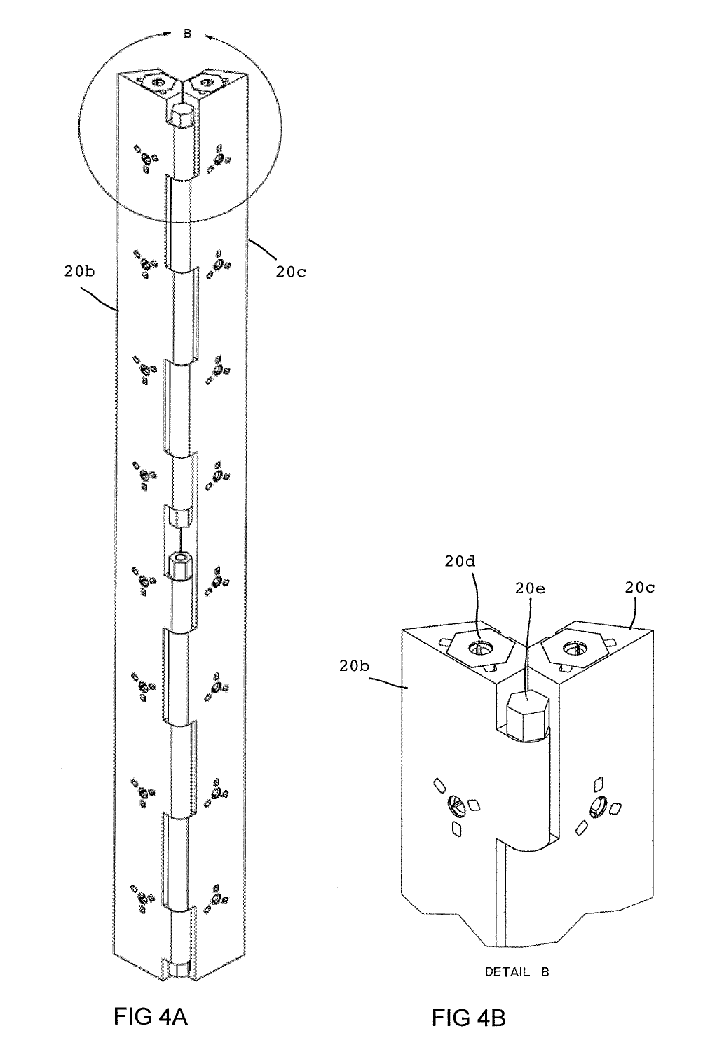

A variation to the fixed-angle vertical manifold is a hinged vertical manifold capable of at least two different angular configurations for the rapid assembly of differently shaped structures (square, rectangular or hexagonal). Two halves 20b, 20c of the vertical manifold 20 is pinned with pins 20e inserted through the hinge joints forming the vertical corner, as shown in FIGS. 4A and 4B. The hinged manifold is capable of rotating between 90 to 120 degrees. Integrated latches, as well as hard-stops in the top and base panel assembly will lock the hinged manifold at the correct angle for the particular shape of the assembly. Embedded QINs 20d are provided at the ends of the vertical manifolds for attachment of the top and bottom panels.

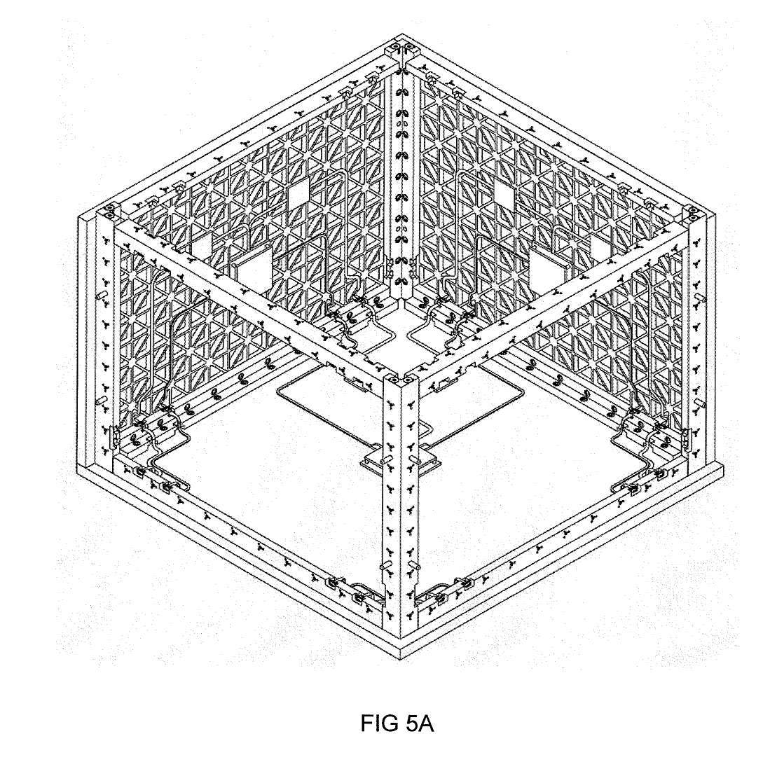

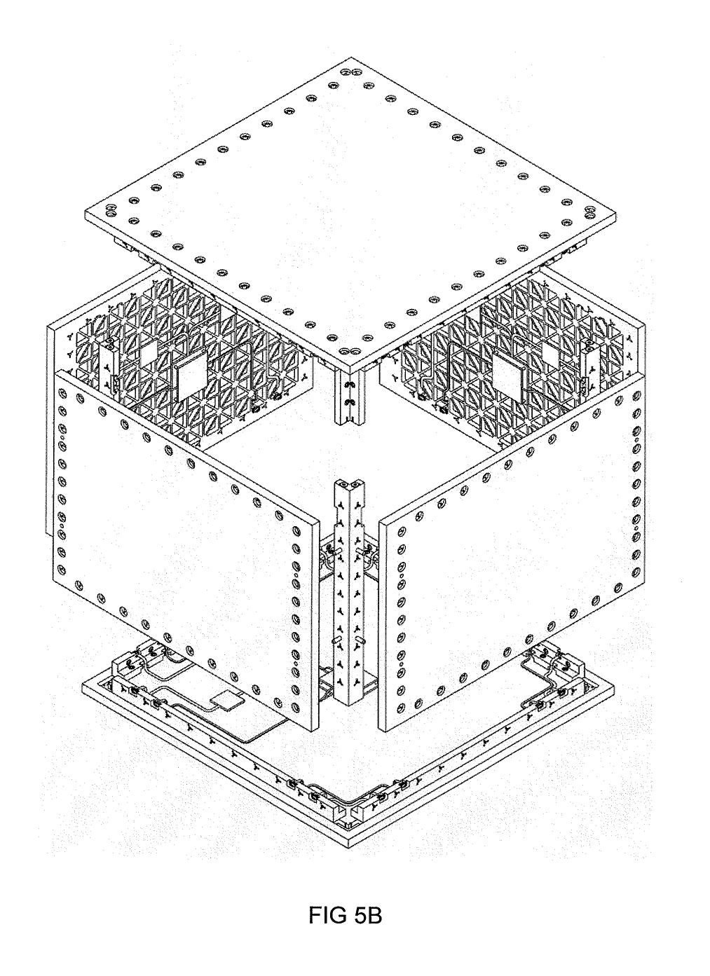

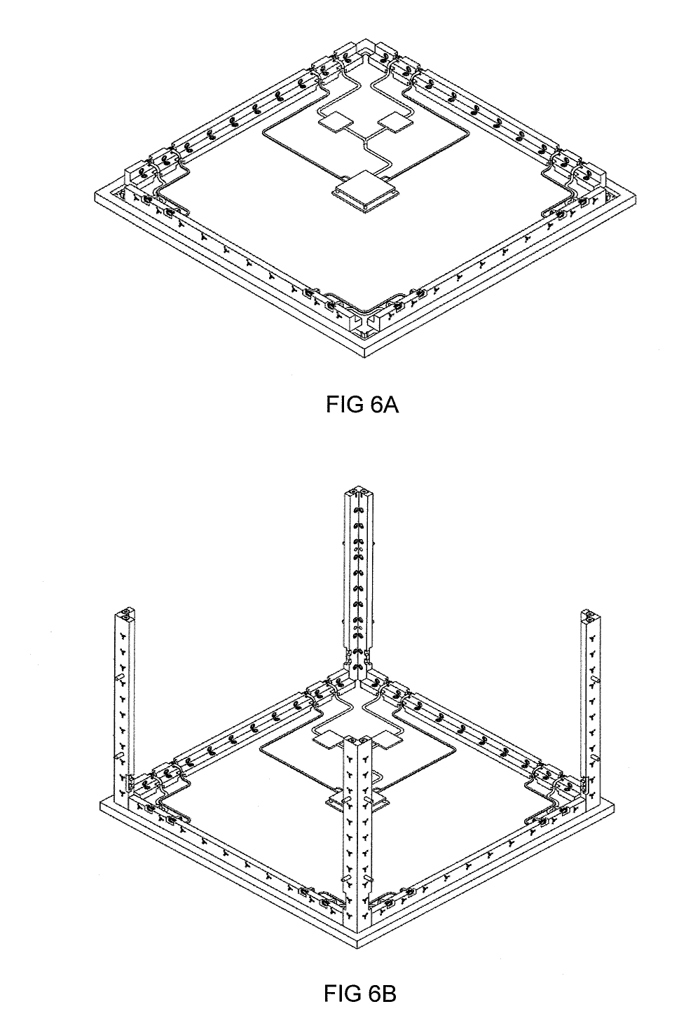

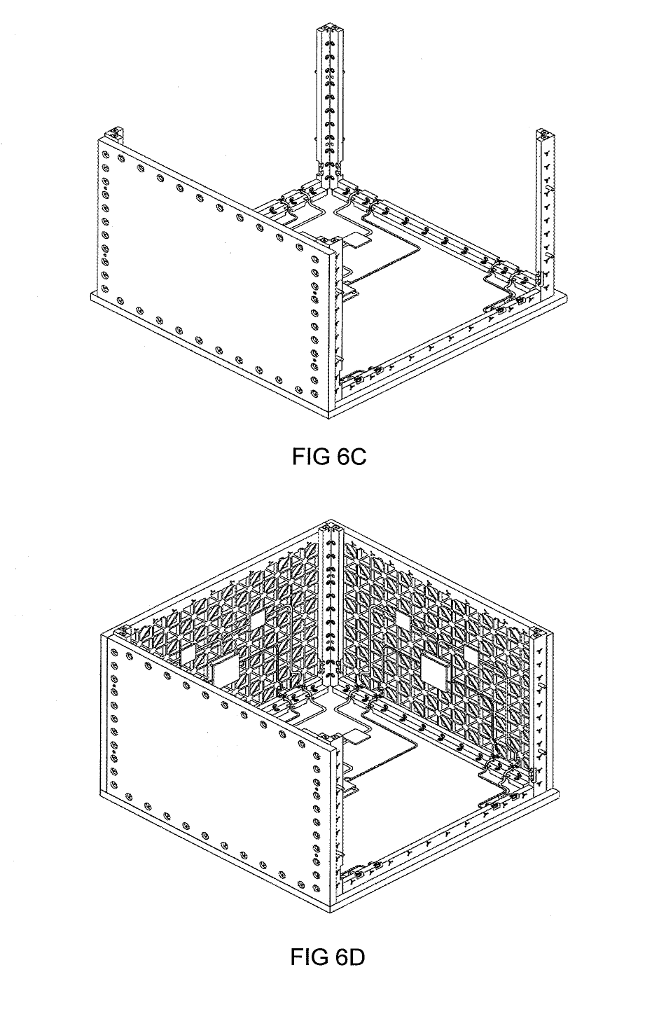

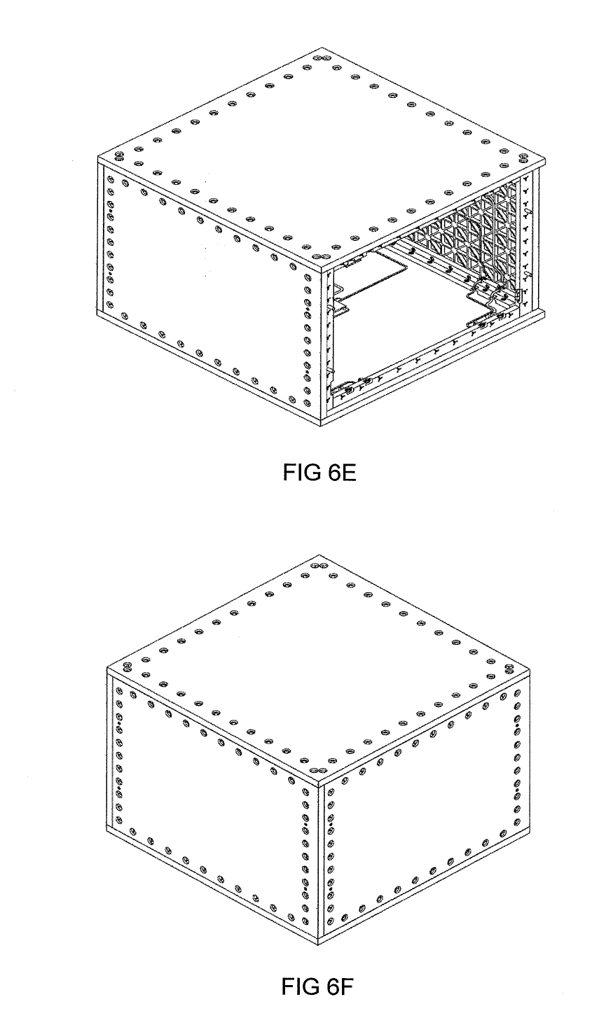

FIGS. 5A and 5B illustrate a partial assembly view and an exploded assembly view for a square-shaped spacecraft with manifolds. FIGS. 6A-6E illustrate the assembly sequence in steps for a square-shaped spacecraft, although it is understood that similar steps would be used to assemble a spacecraft of other polygonal shapes. In FIG. 6A, the bottom panel is pre-assembled and serves as a base for assembly. In FIG. 6B, the horizontal manifolds are attached along the horizontal sides of the bottom panel, and the vertical manifolds are attached at the respective corners of the bottom panel. In FIG. 6C, a first side panels is attached across two of the vertical manifolds, and in FIG. 6D two other side panels are similarly attached. In FIG. 6E, the top panel with pre-assembled components is attached to the ends of the vertical manifolds and by the rows of fasteners to the horizontal manifolds, leaving one side open. In FIG. 6F, the open side is closed to form the assembled self-contained apparatus as shown.

Using the manifold and panel structures, the self-contained apparatus, such as a spacecraft or satellite, can be quickly assembled together and inspected. Using a torque wrench to do the final turn on all the fasteners (mated with QINs embedded in the manifolds), the structure is then locked in place. Rapid disassembly of the panels from an integrated structure using standard tooling may be accomplished by removing the fastener's preload and using the quick-removal feature on the patented QIN or a modified version of it.

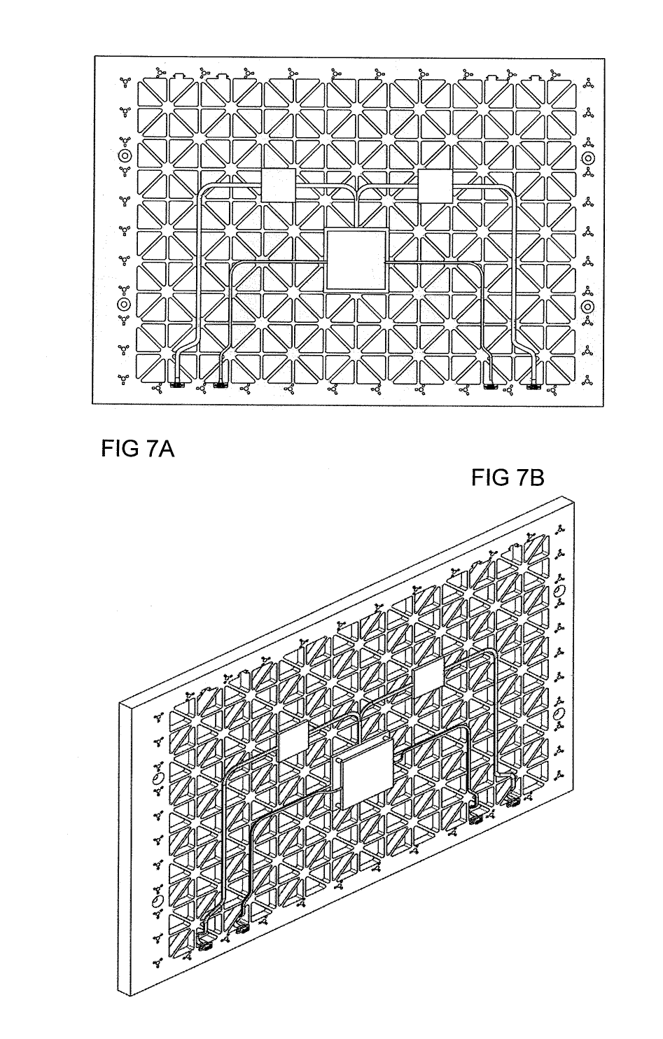

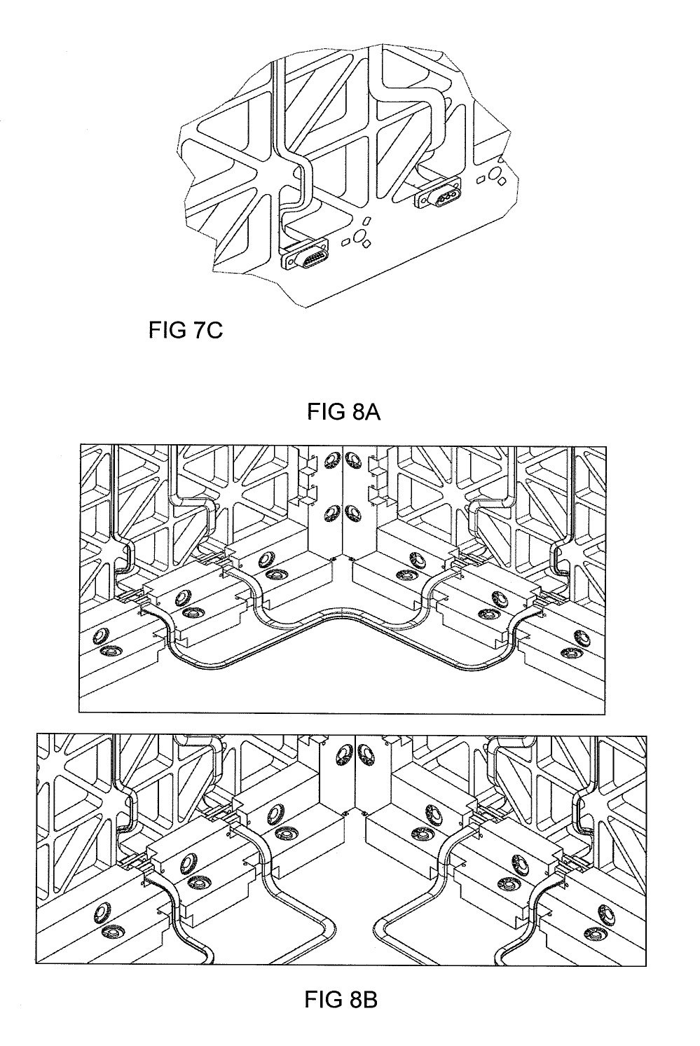

Wire routes and connector mounting locations can be readily incorporated into the panels and the manifolds. The horizontal manifolds on the bottom deck serve as the connection locations to the spacecraft's electrical infrastructure. Power and signal travel from the bottom deck to horizontal manifolds. Mated panels complete the electrical loop via jumper harness on the horizontal manifolds to other panels. One of the side panels will complete the electrical loop to the top panel. An example of wire routes and connector mounting is shown in FIGS. 7A-7C. An example of electrical loop connection is shown in FIGS. 8A and 8B.

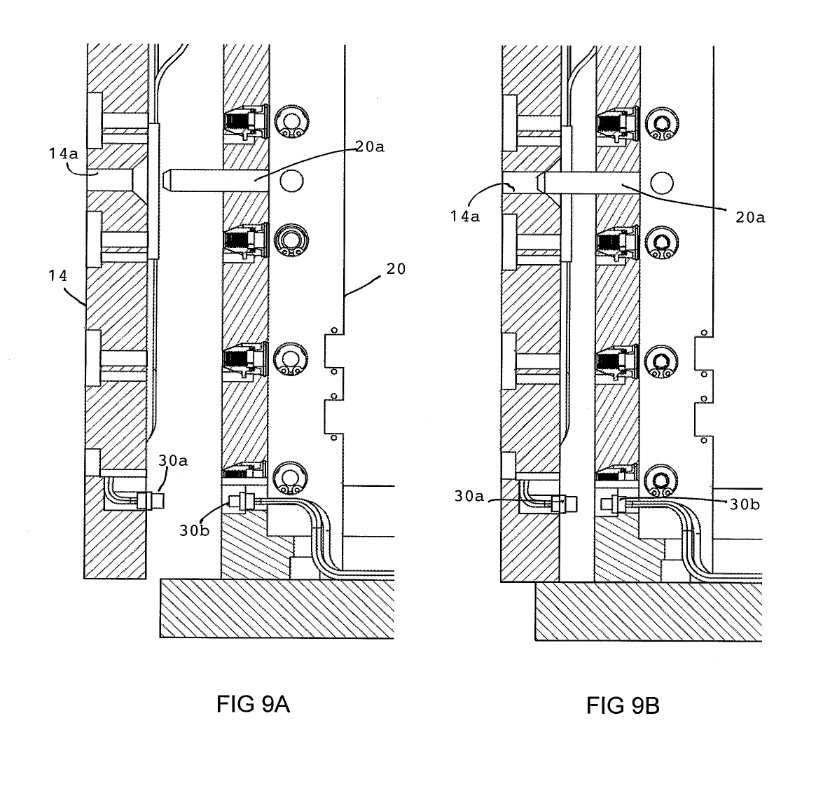

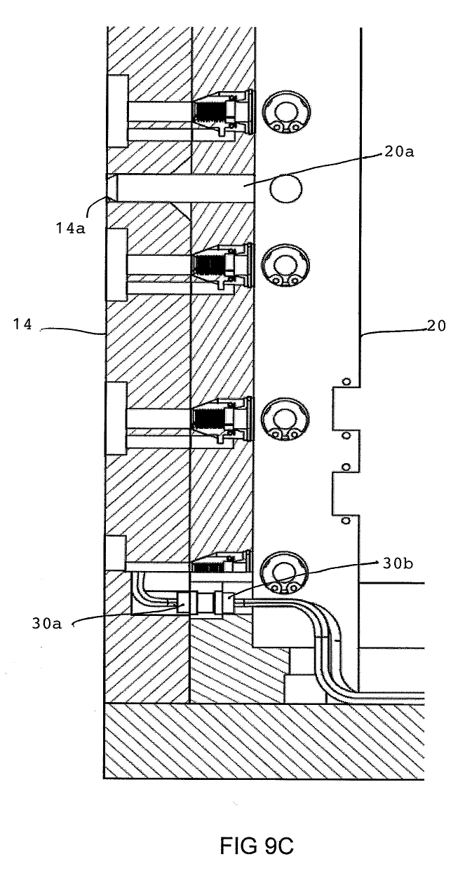

The alignment of the connectors on the panels and the horizontal manifolds are critical during satellite assembly. As shown in FIGS. 9A-9C, tapered holes 14a on the panels 14 and alignment pins 20a on the manifolds 20 are engaged to avoid misalignment of the panel. Since the connectors 30a, 30b on the manifolds are recessed, the connectors on the panel and manifold do not make contact until the panel is centered on the pins, i.e., aligned, and pushed into the manifold. This approach to connector fine alignment may also benefit spacecraft alignment considerations for pointing accuracy. In a similar manner to the electrical connections outlined above, a thermal transfer fluid loop can be integrated into the design.

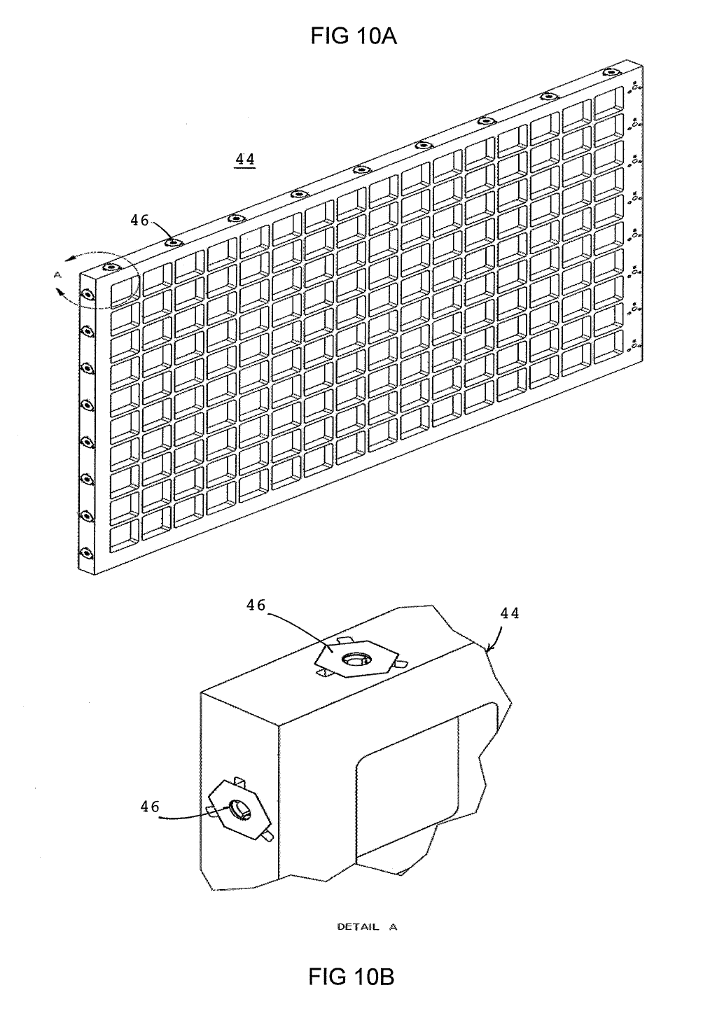

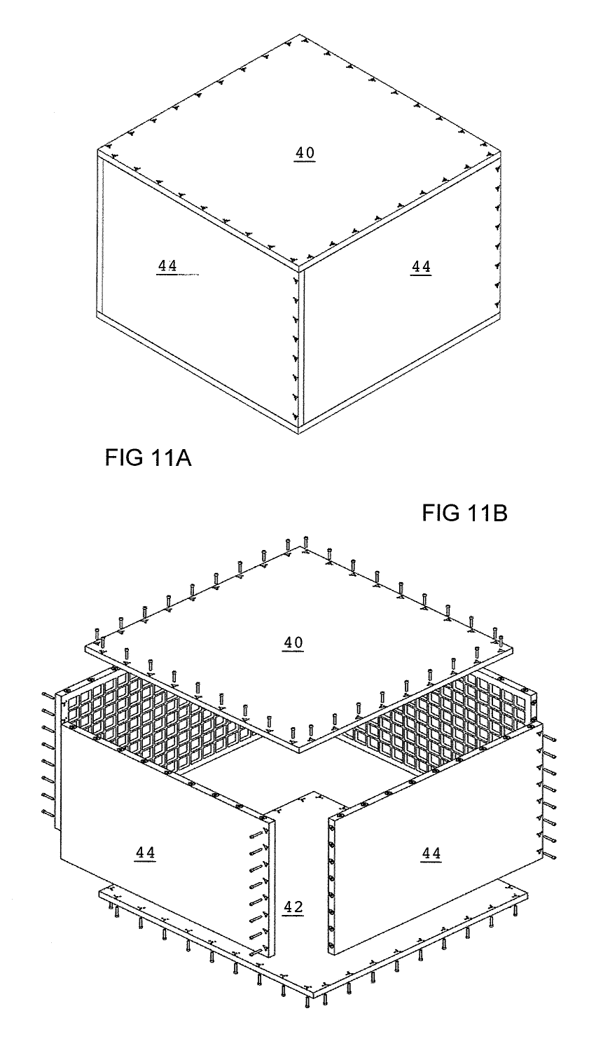

FIGS. 10A and 10B illustrate an alternate embodiment of the invention in which quick-insertion-nut (QIN) assemblies 46 are embedded into the edges of the side panels 44 to eliminate the use of manifolds. FIGS. 11A and 11B show an assembled view and an exploded view, respectively, of the alternate embodiment using the embedded quick-insertion-nut (QIN) assemblies 46 to fasten top panel 40 and bottom panel 42 directly to the edges of side panels 44. Each side panel has longitudinal top and bottom edges to which the top and bottom panels are attached, and one vertical edge on one lateral side to which a vertical edge on an opposite side of an adjoining side panel is attached. The longitudinal edges and the one vertical edge of each side panel is provided with a row of quick-insertion-nut (QIN) assemblies that are embedded into the edges of the side panels. The top and bottom panels are attached by fasteners inserted on external sides into the QIN assemblies on the longitudinal top and bottom edges of the side panels, and each side panel is attached to an adjoining side panel by fasteners inserted on external sides into the QIN assemblies on the other vertical edge of the adjoining side panel

Bolted joints usually induce high stress concentrations at the threaded interface. To overcome high stress, a significant allocation of mass is required. In the current assembly of satellites, fastener inserts (usually heli-coils) are embedded into the aluminum ribbed or honeycomb panel structures to deal with this high stress concentration. Replacing the fastener inserts with quick insertion nuts is an alternate method of accomplishing the same advantages of inserts as well as aiding rapid installation of the fasteners onto the satellite structure.

In summary, the invention provides advantages over the prior art by enabling a self-contained apparatus, such as a spacecraft or satellite, to be rapidly assembled using standard panels and manifolds. With sufficient testing beforehand and stock components warehoused, the invention permits a spacecraft to be physically built in about a week. Using the skeletal frame design of the main embodiment ensures that the resulting structure would have higher modal frequencies and better thermal transfer and distribution across the joints and therefore, around the spacecraft. The invention also enables simultaneous electrical connections across the spacecraft joints when the structure is assembled. Simultaneous coupling of thermal transfer fluid loops are also enabled by the invention.

It is to be understood that many modifications and variations may be devised given the above description of the general principles of the invention. It is intended that all such modifications and variations be considered as within the spirit and scope of this invention, as defined in the following claims.

1. A means for rapid assembly of a self-contained apparatus comprising:
horizontal and vertical structural manifolds which are joined at corners with one another to form a rigid self-contained frame, and
a plurality of side panels attached by fasteners inserted on external sides thereof into the vertical manifolds, and
top and bottom panels attached by fasteners inserted on external sides thereof into the horizontal manifolds,
whereby the vertical and horizontal manifolds enable side panel-to-panel attachment at vertical and horizontal corners, and horizontal manifolds enable top and bottom panel attachment at horizontal corners with the side panels, and the combination of vertical and horizontal manifolds creates a skeletal frame for the self-contained apparatus to which the top, bottom and side panels are attached to the manifolds.

2. A means for rapid assembly of a self-contained apparatus as in claim 1, wherein cutout sections are provided proximate opposite ends of each manifold to enable electrical and/or fluid lines to be emplaced on internal sides of the panels with recessed seating and continuity across the vertical and horizontal corners formed by the manifolds.

3. A means for rapid assembly of a self-contained apparatus as in claim 1, wherein the vertical manifolds each have manifold halves arranged at an angle to each other that determines the shape of the self-contained apparatus.

4. A means for rapid assembly of a self-contained apparatus as in claim 3, wherein a 90-degree angled vertical manifold creates a frame for a square or rectangular shaped apparatus.

5. A means for rapid assembly of a self-contained apparatus as in claim 3, wherein a 120-degree angled vertical manifold creates a frame for a hexagonal shaped apparatus.

6. A means for rapid assembly of a self-contained apparatus as in claim 1, wherein the horizontal manifolds have manifold halves arranged at an angle to each other, and an external surface of each manifold half has a row of alignment holes along its length for receiving fastener bolts inserted from an external side of an attached panel.

7. A means for rapid assembly of a self-contained apparatus as in claim 6, wherein an internal surface of each manifold half has a row of integrated receptacles for holding quick-insertion nuts therein.

8. A means for rapid assembly of a self-contained apparatus as in claim 1, wherein the vertical manifolds have quick-insertion nuts embedded on opposite ends thereof for enabling fastening of the top and bottom panels to the ends of the vertical manifolds by insertion of fastener bolts on external sides thereof.

9. A means for rapid assembly of a self-contained apparatus as in claim 1, wherein the vertical manifold is hinged vertical manifold capable of at least two different angular configurations for the rapid assembly of differently shaped structures (square, rectangular or hexagonal).

10. A means for rapid assembly of a self-contained apparatus as in claim 1, wherein the panels have tapered holes into which alignment pins on the manifolds are engaged to avoid misalignment of the panels.

11. A means for rapid assembly of a self-contained apparatus as in claim 1, wherein said apparatus is a spacecraft.

12. A means for rapid assembly of a self-contained apparatus as in claim 1, wherein said apparatus is a satellite.

13. A means for rapid assembly of a self-contained apparatus comprising:
a plurality of side panels each having longitudinal top and bottom edges to which top and bottom panels are to be attached, and one vertical edge on one lateral side thereof to which a vertical edge on an opposite side of an adjoining side panel is to be attached, wherein said longitudinal edges and said one vertical edge of each side panel is provided with a row of quick-insertion-nut (QIN) assemblies that are embedded into the edges of the side panels,
top and bottom panels being attached by fasteners inserted on external sides thereof into the quick-insertion-nut (QIN) assemblies on the longitudinal top and bottom edges of the side panels for attachment thereto, and
each side panel being attached to an adjoining side panel by fasteners inserted on external sides thereof into the quick-insertion-nut (QIN) assemblies on the one vertical edge of the side panel.

14. A means for rapid assembly of a self-contained apparatus as in claim 13, wherein said quick insertion nut is formed with a casing having an internal surface at a front part thereof in a frusto-conical shape with a taper angle, the front part of the casing being oriented toward a bolt end for insertion, a plurality of shell segments being radially arranged on a fastener axis to form a displaceable shell assembly contained in the casing, each of the shell segments having a similar shape with an external surface at a front end thereof tapered in a frusto-conical shape with a taper angle corresponding to the taper of the internal front surface of the casing, a spring positioned at a rear part of the casing to provide an elastic force to elastically hold rear ends of the shell segments together in the shell assembly, and a retainer ring provided at the rear part of the casing having a taper for engaging the rear ends of the shell segments and displacing them radially as they are moved axially toward the end retainer such that the shell segments are spread apart radially to allow insertion of the bolt end past the internal threads of the shell segments when the shell segments are pushed axially by the bolt end into the front part of the casing and toward the ring retainer at the rear part of the casing.
